(19) United States
(12) Patent Application Publication
(10) Pub. No.: US 2025/0178087 A1
(43) Pub. Date: Jun. 5, 2025

(54) METAL POWDER, COMPOSITE MAGNETIC BODY, DUST CORE, AND COIL COMPONENT

(71) Applicant: Panasonic Intellectual Property Management Co., Ltd., Osaka (JP)

(72) Inventors: Yuma SASAKI, Osaka (JP); Junichi KOTANI, Hyogo (JP)

(21) Appl. No.: 18/843,938

(22) PCT Filed: Mar. 16, 2023
(86) PCT No.: PCT/JP2023/010424

§ 371 Date: Sep. 4, 2024

(30) Foreign Application Priority Data
Mar. 30, 2022 (JP) 2022-056763

(51) Int. Cl. B22F 7/08; H01F 1/147; H01F 27/255

(52) U.S. Cl. CPC B22F 7/08; H01F 1/14766; H01F 27/255; B22F 2301/35

(57) ABSTRACT

Metal powder contains Fe as a main element and contains Sn. The Sn content in the metal powder is 6.3 wt % or more.

### TECHNICAL FIELD

The present disclosure relates to metal powder containing Fe as a main element, a composite magnetic body including the metal powder, a dust core, and a coil component.

### BACKGROUND ART

A coil component that includes a dust core, and a coil member inside the dust core is typically known. Known as a material of the dust core is a composite magnetic body including metal powder containing Fe as a main element. It is required for the dust core to reduce the magnetic loss which leads to the energy loss.

For example, Patent Literature (PTL) 1 discloses metal powder with an alloy composition represented by FeSiCrC. PTL 2 discloses metal powder containing Fe as a main element and having smaller average and maximum particle sizes than typical ones.

### Citation List

### Patent Literatures

[PTL 1] International Publication No. WO 2020/054857
[PTL 2] Japanese Unexamined Patent Application Publication No. 2012-54569

### SUMMARY OF INVENTION

### Technical Problems

The metal powder disclosed in PTL 1 contains chrome (Cr) and thus can reduce rust, but has the problem of increasing the eddy current loss of a dust core within a high frequency range. The metal powder disclosed in PTL 2 reduces the eddy current loss by reducing the average particle size of the metal powder, for example. Since the degree of miniaturization of metal powder is limited, the reduction in the eddy current loss is also limited. It is difficult to reduce rust and the eddy current loss in the metal powder disclosed in PTLs 1 and 2.

In view of the problems described above, it is an objective of the present disclosure to provide metal powder, and so on, which can reduce the eddy current loss and rust.

### Solutions to Problems

Metal powder according to an aspect of the present disclosure contains Fe as a main element. The metal powder includes: Sn. A Sn content in the metal powder is 6.3 wt % or more.

A composite magnetic body according to an aspect of the present disclosure includes the metal powder described above and a resin.

A dust core according to an aspect of the present disclosure includes the composite magnetic body described above.

A coil component according to an aspect of the present disclosure includes: a magnetic body that is the composite magnetic body described above; and a coil member at least partially located inside the magnetic body.

### Advantageous Effects of Invention

The metal powder, and so on, according to the present disclosure can reduce the eddy current loss and rust.

### BRIEF DESCRIPTION OF DRAWINGS

FIG. 1 is a general perspective view showing a configuration of a coil component according to an embodiment.

FIG. 2 is an exploded perspective view showing the configuration of the coil component according to the embodiment.

FIG. 3 is a cross-sectional view showing an internal configuration of a dust core according to the embodiment.

FIG. 4 shows a relationship between a value of mass-specific magnetization and the content of the non-magnetic element in Fe-based metal powder.

FIG. 5 is a graph showing magnetic losses of dust cores according to examples and comparative examples.

FIG. 6 shows a result of evaluation on magnetic losses and rust of the dust cores according to the examples and the comparative examples.

FIG. 7 shows a result of a weathering test of a composite magnetic body including metal powder.

FIG. 8 shows SEM images of the metal powder according to the examples and the comparative examples.

FIG. 9 shows SEM images in a cross-section of metal powder according to the examples and the comparative examples.

FIG. 10 includes enlarged views of SEM images each showing the cross section of the metal powder according to an example.

FIG. 11 includes enlarged views of EDX images each showing the cross section of the metal powder according to the example.

FIG. 12 shows a result of X-ray diffraction of metal powder according to the examples and the comparative examples.

FIG. 13 shows the weight ratio of Sn to Fe.

FIG. 14 is a flowchart showing a manufacturing process of a coil component according to the embodiment.

FIG. 15 is a flowchart showing a step of manufacturing granulated powder according to the embodiment.

FIG. 16 is a flowchart showing a step of manufacturing a core according to the embodiment.

FIG. 17 is a flowchart showing a step of assembling a coil according to the embodiment.

FIG. 18 is a general perspective view showing a configuration of a coil component according to a variation of the embodiment.

FIG. 19 is a cross-sectional view showing the configuration of the coil component according to a variation of the embodiment.

FIG. 20 is a flowchart showing a step of manufacturing the coil component according to the variation of the embodiment.

FIG. 21 is a flowchart showing a step of manufacturing a core and assembling a coil according to the variation of the embodiment.

### Description of Embodiments

Now, an embodiment will be described in detail with reference to the drawings.

The embodiment described below is merely a specific example of the present disclosure. The numerical values, shapes, materials, elements, the arrangement and connection of the elements, steps, step orders etc. shown in the following embodiment are thus merely examples, and are not intended to limit the scope of the present disclosure. Among the elements in the following embodiment, those not recited in the independent claims will be described as optional.

The figures are schematic representations and not necessarily drawn strictly to scale. The scales are thus not necessarily the same in the figures. The same reference signs represent substantially the same configurations in the drawings and redundant description will be omitted or simplified.

In this specification, the terms, such as “parallel” or “orthogonal” representing the relationships between elements, the terms, such as “rectangular” or “parallelepiped” representing the shapes of elements, and numerical ranges are expressions having not only the exact meaning but also covering substantially equivalent ranges, such as the differences of several percentages.

### Embodiment

Now, metal powder, a composite magnetic body containing the metal powder, a dust core including the composite magnetic body, and a coil component including the dust core according to the embodiment will be described.

[Configuration of Coil Component]

Coil component 10 according to this embodiment includes a magnetic body (e.g., a dust core) and a coil member. The magnetic body is a composite magnetic body including metal powder. Coil member 23 is at least partially located inside magnetic body 12. Coil component 10 is an inductor, for example.

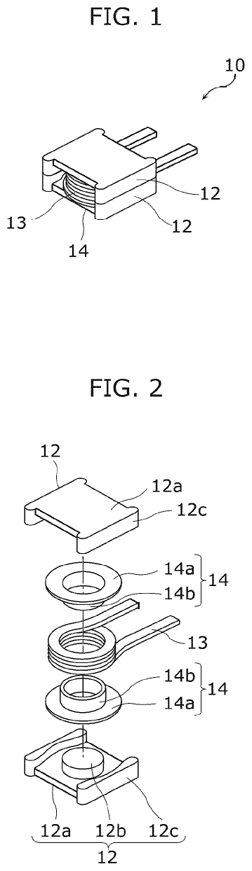

FIG. 1 is a general perspective view showing a configuration of coil component 10 according to this embodiment. FIG. 2 is an exploded perspective view showing the configuration of coil component 10 according to this embodiment.

As shown in FIGS. 1 and 2, coil component 10 includes two dust cores 12 that are two split cores, conductor 13, and two coil supports 14. Two dust cores 12 that are two split cores form a magnetic body, and conductor 13 and two coil supports 14 form a coil member.

Each dust core 12 includes base 12a, and cylindrical core 12b on one surface of base 12a. On a facing pair of four sides forming base 12a, walls 12c stand from the edges of base 12a. Core 12b and walls 12c have the same height from the one surface of base 12a. Each of two dust cores 12 is obtained by pressure molding of a composite magnetic body into a predetermined shape.

Two dust cores 12 are arranged with their cores 12b and walls 12c abutting on each other. At this time, conductor 13 surrounds cores 12b. Conductor 13 are incorporated into dust cores 12 via coil supports 14.

As shown in FIG. 2, two coil supports 14 each include ring-shaped base 14a and cylinder 14b. Core 12b of associated dust core 12 is located inside cylinder 14b, and conductor 13 is located on the outer periphery of cylinder 14b.

[Configuration of Dust Core]

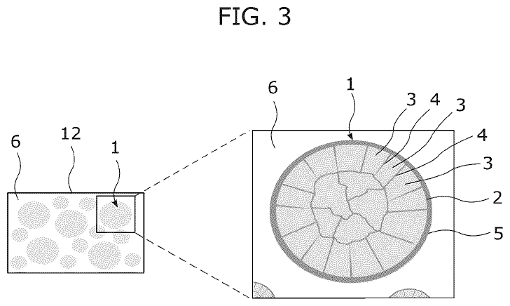

FIG. 3 is a cross-sectional view showing an internal configuration of dust core 12. FIG. 3 schematically shows the area including metal powder 1 in the internal cross section of dust core 12.

As shown in FIG. 3, dust core 12 includes metal powder 1 that is magnetic powder, and non-magnetic resin member 6 that binds the grains of metal powder 1. In addition, dust core 12 may further include a coupling agent for improving the dispersion of metal powder 1 and modifying the surface of metal powder 1, and an organic metal soap as a lubricant. Examples of the coupling agent include a silane coupling agent, a titanium-based coupling agent, titanium alkoxide, and titanium chelate. Examples of the metal soap include zinc stearate, calcium stearate, magnesium stearate, and barium stearate.

Non-magnetic resin member 6 binds the grains of metal powder 1. Non-magnetic resin member 6 keeps the shape of dust core 12. Non-magnetic resin member 6 is made of an insulating resin material. The resin material of non-magnetic resin member 6 is a thermosetting resin, for example. The resin material of non-magnetic resin member 6 may be a thermoplastic resin. Alternatively, the resin material may be a combination of a thermosetting resin and a thermoplastic resin. Examples of the thermosetting resin include an epoxy resin, a phenol resin, a silicone resin, and polyimide. Examples of the thermoplastic resin include an acrylic resin, polyethylene, polypropylene, and polystyrene. Non-magnetic resin member 6 has a weight within a range from 1% to 10%, for example, with respect to the weight of metal powder 1.

A large number of grains of metal powder 1 is dispersed in dust core 12. The surface of metal powder 1 is covered with non-magnetic resin member 6. Non-magnetic resin members 6 covering the surfaces of adjacent grains of metal powder 1 bind to each other. That is, each non-magnetic resin member 6 is interposed between the grains of metal powder 1 to insulate the grains of metal powder 1 from each other.

Metal powder 1 has median diameter D50 within a range from 5 μm to 40 μm, for example. Median diameter D50 within this range ensures a high filling rate and ease of handling. Metal powder 1 with median diameter D50 of 40 μm or less can reduce the core loss, particularly, the eddy current loss within a high-frequency range. Note that median diameter D50 of metal powder 1 is obtained as follows. The particle sizes are measured by laser diffraction scattering method. The median diameter D50 means a particle diameter at 50% integrated volume value in the particle size distribution.

[Configuration of Metal Powder]

Metal powder 1 is, for example, a metal soft magnetic particle containing iron (Fe) as a main element, and contains tin (Sn) in addition to Fe. Metal powder 1 may further contain silicon (Si). The elements contained in metal powder 1 will be described below.

Fe is the main element of metal powder 1. Being the “main element” means that the content (unit: weight % (wt %)) is the highest among the elements contained in metal powder 1. In view of the saturation flux density (Bs) of the dust core including metal powder 1, the Fe content in metal powder 1 falls within a range from 80 wt % to 93.7 wt % in one preferred embodiment.

Sn has a nobler redox potential than Fe, and has the advantage of reducing the magnetic loss, particularly, the eddy current loss within a high-frequency range. A predetermined amount or more of Sn contained in metal powder 1 can reduce the occurrence of rust at dust core 12 including metal powder 1 and the eddy current loss. Metal powder 1 according to this embodiment has a Sn content of 6.3 wt % or more. An example of the Sn content of 6.3% will be described using the result of evaluation below.

Si has the advantage of reducing the coercivity of the dust core. Si also has the advantage of increasing the electrical resistivity and reducing the eddy current loss. A predetermined amount or more of Si contained in metal powder 1 can reduce the coercivity of the dust core and the eddy current loss. Since Si is not necessarily contained in metal powder 1, the Si content in metal powder 1 is 0% or more in this embodiment.

The above-described Sn and Si are non-magnetic elements. With an increase in the Sn and Si contents in metal powder 1, the Fe content decreases and the saturation flux density (Bs) decreases. In order to cause metal powder 1 to function as magnetic powder, predetermined upper limits are set to the Sn and Si contents with respect to Fe.

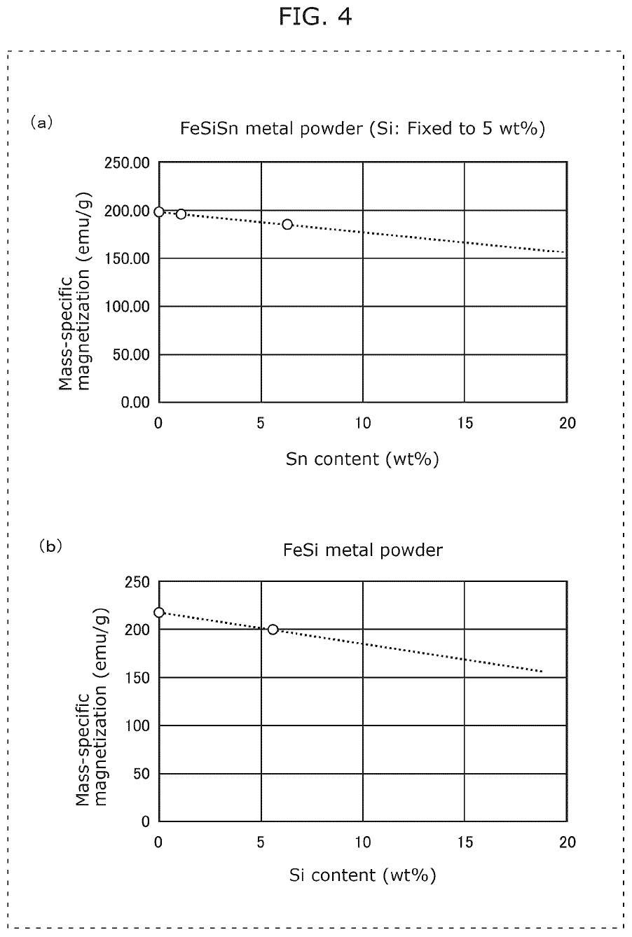

FIG. 4 shows a relationship between a value of mass-specific magnetization and the content of the non-magnetic element in Fe-based metal powder. The relationship holds in which metal powder with a lower value of mass-specific magnetization reduces the saturation flux density of the dust core including metal powder. To address the problem, the present inventors have focused on the mass-specific magnetization of Fe-based metal powder, and induced the upper limits of the Sn and Si contents.

In FIG. 4, (a) shows the value of mass-specific magnetization of the Fe-based metal powder with the Sn content changed. The materials of the Fe-based metal powder are Fe, Si, and Sn as in the embodiment. Note that the Si content is fixed to 5 wt %. As shown in (a) of FIG. 4, with an increase in the Sn content, the value of mass-specific magnetization decreases. In order to cause the Fe-based metal powder to function as magnetic powder, the Sn content is 20 wt % or less, for example, in one preferred embodiment.

In FIG. 4, (b) shows the value of mass-specific magnetization of the Fe-based metal powder with the Si content changed. The materials of the Fe-based metal powder are Fe and Si without Sn. As shown in (b) of FIG. 4, with an increase in the Si content, the value of mass-specific magnetization decreases. Thus, in order to cause the Fe-based metal powder to function as magnetic powder, the Sn content is 8 wt % or less, for example, in one preferred embodiment. The Si content is 5.2 wt % or less in one more preferred embodiment.

That is, the metal composition of metal powder 1 according to this embodiment is expressed by Fe_{100-x-y}SiₓSn_{y} and the composition ratios have the relation meeting 0≤x≤8 and 6.3≤u≤20. In view of the saturation flux density, the composition ratio described above meets x+y≤20.

In this manner, metal powder 1 contains Fe as a main element and has the relationship of a Sn content within a range from 6.3 wt % to 20 wt % and a Si content within a range from 0 wt % to 8 wt %. Particularly in this embodiment, a Sn content of 6.3 wt % or more can reduce the occurrence of rust at dust core 12 including metal powder 1 and the eddy current loss.

In addition, metal powder 1 according to this embodiment has the following powder structure to reduce the occurrence of rust and the eddy current loss.

As shown in FIG. 3, metal powder 1 includes a large number of crystals 3. Grain boundaries 4 are present between adjacent crystals 3 inside metal powder 1. In other words, each crystal 3 is surrounded by grain boundaries 4.

Metal powder 1 includes internal region 2, which is the inside of metal powder 1, and surface region 5 surrounding internal region 2. Surface region 5 of metal powder 1 is located on the outermost surface of the particle including crystals 3 and grain boundaries 4. Metal powder 1 is in contact with non-magnetic resin member 6 via this surface region 5.

Metallic Sn or a Fe—Sn alloy is present in each of grain boundaries 4 and surface region 5. The weight ratio of Sn to Fe and the Sn concentration are both higher in each of grain boundaries 4 and surface region 5 than inside crystal 3. At least one of grain boundaries 4 or surface region 5 needs to be a region with a higher Sn concentration.

The region with a higher Sn concentration can be formed, for example, by setting the amount of Sn added to the molten metal to exceed the solid solubility limit, when metal powder 1 is generated by an atomizing method. When an amount of Sn over the solid solubility limit is contained in the molten metal, supersaturated Sn deposits when the molten metal is rapidly cooled from a molten state into a powder body. The supersaturated Sn deposits as metallic Sn or a Fe—Sn alloy to grain boundaries 4 and surface region 5. As a result, the Sn concentrations become higher at grain boundaries 4 and surface region 5 than inside crystal 3.

The above configuration allows grain boundaries 4 containing a higher weight ratio of Sn to cover crystal 3 inside metal powder 1. The above configuration also allows surface region 5 containing a higher weight ratio of Sn to cover internal region 2 of metal powder 1. This can reduce the occurrence of rust at dust core 12 including metal powder 1 and the eddy current loss.

[Result of Evaluation on Magnetic Loss and Rust]

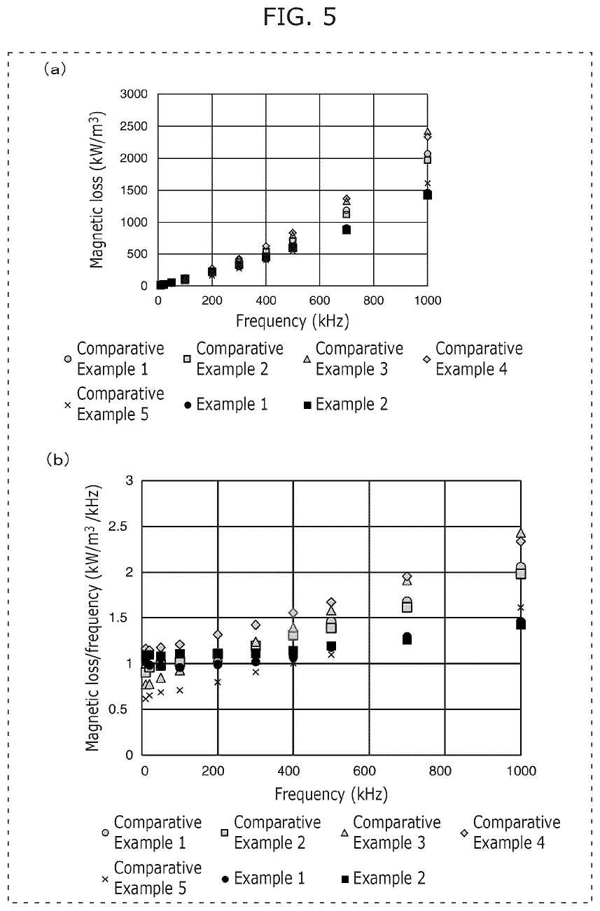

Advantages of metal powder 1 according to the embodiment will be described with reference to FIGS. 5 to 7.

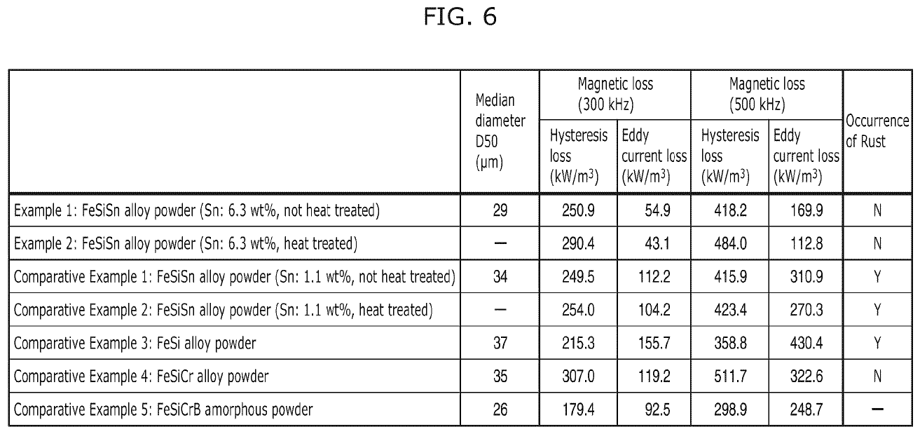

FIG. 5 is a graph showing the magnetic losses of dust cores according to examples and comparative examples. FIG. 6 shows a result of evaluation on the magnetic losses and rust of the dust cores according to the examples and the comparative examples.

First, metal powder 1 according to Examples 1 and 2 that are examples of the embodiment, and metal powder according to Comparative Examples 1 to 5 different from the embodiment.

Metal powder 1 according to Example 1 is the magnetic powder containing Fe as a main element, 5.2 wt % of Si, and 6.3 wt % of Sn. Metal powder 1 according to Example 1 has median diameter D50 of 29 μm. Metal powder 1 according to Example 1 is not subjected to heat treatment. Metal powder generated by an atomizing method, for example, is then not subjected to heat treatment.

Metal powder 1 according to Example 2 is the magnetic powder containing Fe as a main element, 5.2 wt % of Si, and 6.3 wt % of Sn. Metal powder 1 according to Example 2 is the metal powder corresponding to the metal powder according to Example 1 but subjected to heat treatment. The metal powder generated by an atomizing method, for example, is subjected to heat treatment under a nitrogen atmosphere at 400° C. for 2.5 hours. Metal powder 1 according to Example 1 and Example 2 each have a higher Sn content than the Si content. Example 1 and Example 2 each have a higher Sn content than Comparative Example 1 and Comparative Example 2.

The metal powder according to Comparative Example 1 is the magnetic powder containing Fe as a main element, 5.4 wt % of Si, and 1.1 wt % of Sn. The metal powder according to Comparative Example 1 has median diameter D50 of 34 μm. The metal powder according to Comparative Example 1 is not subjected to heat treatment.

The metal powder according to Comparative Example 2 is the magnetic powder containing Fe as a main element, 5.4 wt % of Si, and 1.1 wt % of Sn. The metal powder according to Comparative Example 2 is the metal powder corresponding to the metal powder according to Comparative Example 2 but subjected to heat treatment. The metal powder generated by an atomizing method, for example, is subjected to heat treatment under a nitrogen atmosphere at 400° C. for 2.5 hours.

The metal powder according to Comparative Example 3 is the magnetic powder containing Fe as a main element and 5.5 wt % of Si.

The metal powder according to Comparative Example 3 has median diameter D50 of 37 μm. The metal powder according to Comparative Example 3 contains no Sn.

The metal powder according to Comparative Example 4 is the magnetic powder containing Fe as a main element, 5.3 wt % of Si, and 2.9 wt % of Cr. The metal powder according to Comparative Example 4 has median diameter D50 of 35 μm. The metal powder according to Comparative Example 4 contains no Sn.

The metal powder according to Comparative Example 5 is the amorphous-based magnetic powder containing Fe as a main element, Si, Cr, and B. The metal powder according to Comparative Example 5 has median diameter D50 of 26 μm. The metal powder according to Comparative Example 5 contains no Sn.

In FIG. 5, (a) shows a graph with the vertical axis representing the magnetic loss and the horizontal axis representing the frequency. In FIG. 5, (b) shows a graph with the vertical axis representing the “magnetic loss/frequency” and the horizontal axis representing the frequency. As shown in (a) of FIG. 5, with an increase in the frequency, the magnetic loss of the dust core increases. The increasing rates of the magnetic loss in Example 1 and Example 2 are however lower than those in Comparative Examples 1 to 5. That is, Examples 1 and 2 reduce more magnetic loss within the high-frequency range than Comparative Examples 1 to 5.

FIG. 6 shows the magnetic loss within a frequency range from 300 kHz to 500 kHz divided into the hysteresis loss and the eddy current loss. The hysteresis loss is an intercept of the linear equation expressed by (b) of FIG. 5, while the eddy current loss is the slope of the linear equation expressed by (b) of FIG. 5.

Specifically, the hysteresis loss and the eddy current loss shown in FIG. 6 are induced based on the following Equations (1). The residual loss is believed to be ignorable in this example.

$$\begin{matrix}[ Math . 1 ] & \\ \begin{matrix}{P}_{cv} = {P}_{h} + {P}_{e} \\ {P}_{h} = {k}_{h} f \\ {P}_{e} = {k}_{e} {f}^{2}\end{matrix} & ( 1 )\end{matrix}$$

P_{cv}: magnetic loss, Pₕ: hysteresis loss, Pₑ: eddy current loss kₕ, kₑ: coefficient, f: frequency

As shown in FIG. 6, Example 1 containing 6.3 wt % of Sn has a smaller eddy current loss than Comparative Example 1 containing 1.1 wt % of Sn. Example 2 containing 6.3 wt % of Sn also has a smaller eddy current loss than Comparative Example 2 containing 1.1 wt % of Sn. The content of Sn at 6.3 wt % can reduce more eddy current loss than the case with 1.1 wt % of Sn.

Example 2 subjected to heat treatment has a further smaller eddy current loss than Example 1 not subjected to heat treatment. In this manner, the heat treatment of metal powder 1 can further reduce the eddy current loss. The heat treatment allows surface region 5 of metal powder 1 to deposit a larger amount of Sn and can further reduce the eddy current loss.

Now, a result of evaluation on rust will be described.

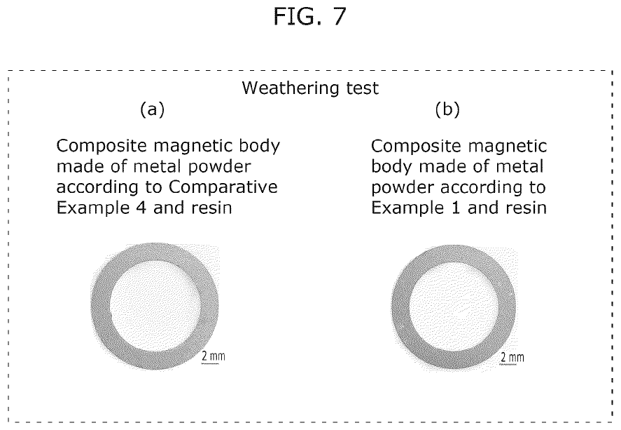

FIG. 7 shows a result of a weathering test on a composite magnetic body including metal powder.

In FIG. 7, (a) shows a ring-shaped composite magnetic body made of the metal powder according to Comparative Example 4 and a silicone resin. In FIG. 7, (b) shows a ring-shaped composite magnetic body made of metal powder 1 according to Example 1 and a silicone resin. Each figure shows an image of a composite magnetic body captured by a stereo microscope after the weathering test. The weathering test was conducted by placing the composite magnetic body under the conditions of the temperature 85° C. and the relative humidity (RH) of 85% and evaluating whether rust occurs after three weeks later.

As shown in (a) of FIG. 7, no rust occurs in the composite magnetic body made of the metal powder according to Comparative Example 4 containing Cr. On the other hand, as shown in (b) of FIG. 7, no rust occurs in the composite magnetic body made of metal powder 1 according to Example 1, either.

The same test as the weathering test described above was conducted for Example 2 and Comparative Examples 1 to 3. The results are shown on the right column of FIG. 6 using the letter “N” for the example with no rust and the letter “Y” for the example with rust.

As shown in FIG. 6, no rust has occurred in Example 2, but rust has occurred in Comparative Examples 1 to 3. The content of Sn at 6.3 wt % as shown in Examples 1 and 2 can reduce more rust than the case with 1.1 wt % of Sn as shown in Comparative Examples 1 and 2.

[Powder Body Structure of Metal Powder]

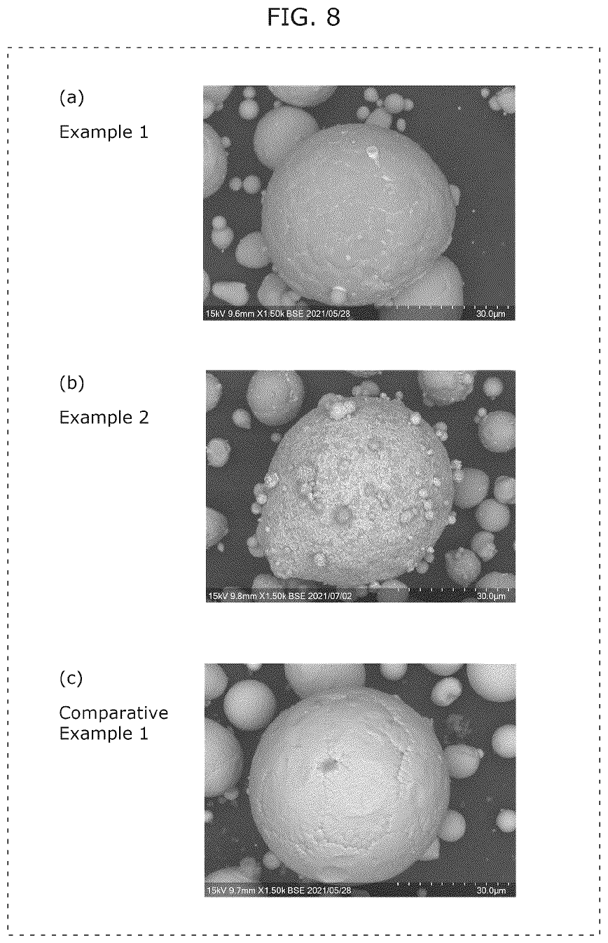

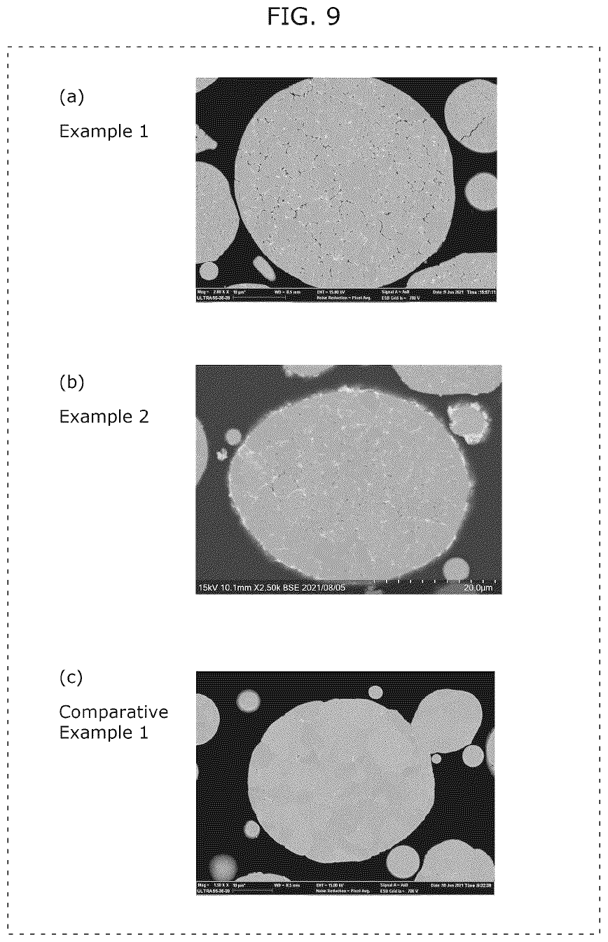

Now, the powder body structures of the metal powder according to the examples and the comparative examples will be described with reference to FIGS. 8 to 12. The SEM images shown in FIG. 8 were obtained using a scanning electron microscope (SEM) analyzer after adhering metal powder to a conductive carbon tape. The SEM images or the EDX images shown in FIGS. 9 to 11 were obtained using an SEM or an energy dispersive X-ray (EDX) analyzer after embedding the dust core in a resin and performing mechanical polishing, and a cross section for observation is formed by ion milling.

FIG. 8 shows SEM images of metal powder according to the examples and the comparative examples.

In FIG. 8, (a) shows metal powder 1 according to Example 1, (b) shows metal powder 1 according to Example 2, and (c) shows the metal powder according to Comparative Example 1. In FIG. 8, the metal powder contained in the dust core is colored in gray, and the conductive carbon tape is colored in black. As shown in these figures, metal powder 1 according to Examples 1 and 2 have more unevenness than the metal powder according to Comparative Example 1. Metal powder 1 according to Example 2 has more granular protrusions on the surface of the sphere than metal powder 1 according to Example 1.

FIG. 9 shows SEM images in a cross section of metal powder according to the examples and the comparative examples.

In FIG. 9, (a) shows metal powder 1 according to Example 1, (b) shows metal powder 1 according to Example 2, and (c) shows the metal powder according to Comparative Example 1. In FIG. 9, (a) shows an image of the same dust core as in (a) of FIG. 8 captured at a different point of the metal powder from (a) of FIG. 8. The same applies to the relation between (b) of FIG. 9 and (b) of FIG. 8, and the relation between (c) of FIG. 9 and (c) of FIG. 8.

In FIG. 9, the metal powder contained in the dust core is colored in gray, and the non-magnetic resin member is colored in black. In metal powder 1 according to Examples 1 and 2, grain boundaries 4 in metal powder 1 are colored in white (i.e., a paler color than gray). In metal powder 1 according to Example 2, surface region 5 is colored in white (i.e., a paler color than gray).

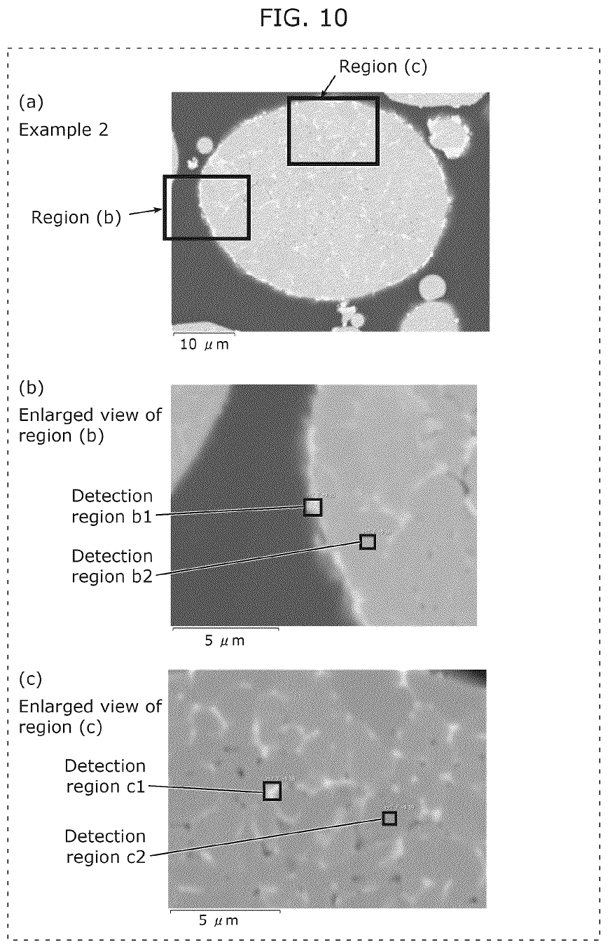

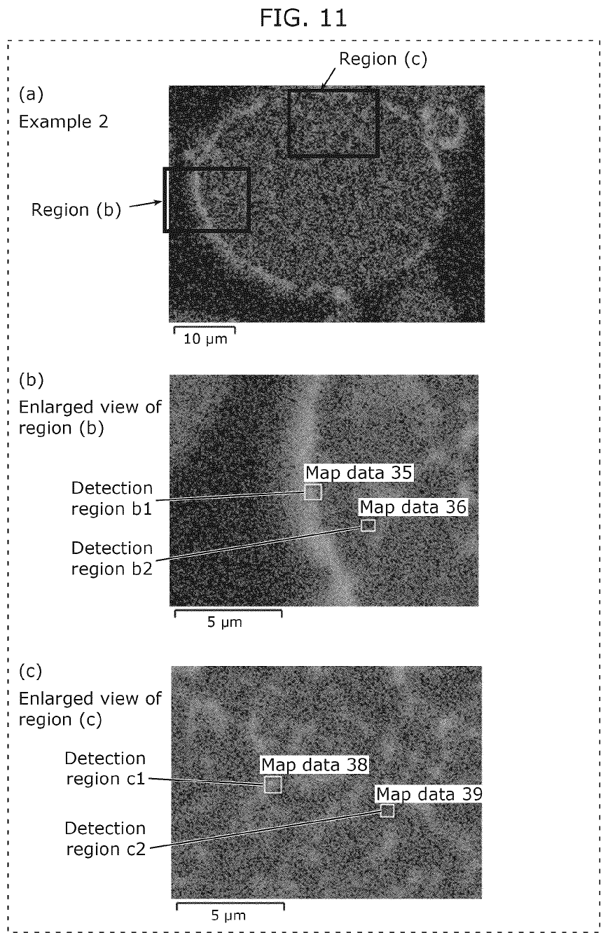

FIG. 10 includes enlarged views of SEM images each showing a cross-section of metal powder 1 according to Example 2. FIG. 11 includes enlarged views of EDX images each showing a cross-section of metal powder 1 according to Example 2.

Like (b) of FIG. 9, (a) of FIG. 10 shows an SEM image showing a cross-section of metal powder 1 according to Example 2. This figure shows region (b) including surface region 5 and region (c) including grain boundaries 4.

In FIG. 10, (b) is an enlarged view of region (b) including surface region 5. Shown in region (b) are: detection region b1 corresponding to surface region 5; and detection region b2 corresponding to the inside of crystal 3.

In FIG. 10, (c) is an enlarged view of region (c) including grain boundary 4. Shown in region (c) are: detection region c1 corresponding to grain boundary 4, and detection region c2 corresponding to the inside of crystal 3.

In FIG. 11, (a), (b), and (c) show EDX images of imaging regions corresponding to (a), (b), and (c) in FIG. 10. FIG. 11 shows Sn elements detected by the EDX in gray (i.e., a paler color than black), and elements other than Sn in black. As shown in (b) of FIG. 11, a Sn element is detected in surface region 5 of metal powder 1 according to Example 2. As shown in (c) of FIG. 11, a Sn element is detected at grain boundary 4 of metal powder 1 according to Example 2.

As shown in FIGS. 10 and 11, a larger number of Sn elements are present in surface region 5 than inside crystal 3 of metal powder 1 according to Example 2. In metal powder 1 according to Example 2, a larger number of Sn elements are present at grain boundaries 4 than inside crystal 3. The Sn element is presumed to be present in the form of a metallic Sn or a Fe—Sn alloy.

Here, how many and how the Sn elements are present in detection regions b1, b2, c1, and c2 will be described.

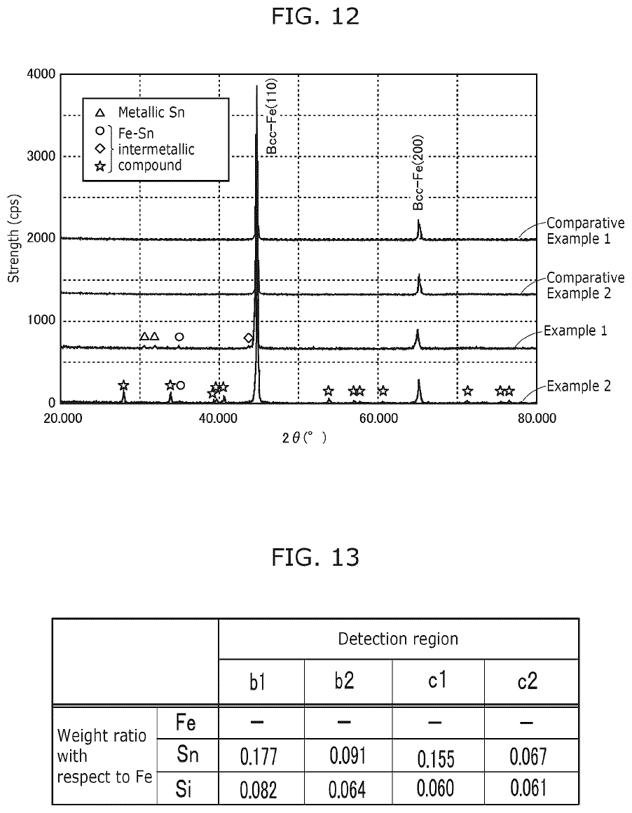

FIG. 12 shows results of X-ray diffraction of metal powder 1 according to the examples.

The data in FIG. 12 shows the X-ray diffraction patterns of metal powder 1 according to Example 2 obtained using a powder X-ray Diffractometer (XRD). FIG. 12 also shows the X-ray diffraction patterns of the metal powder according to Example 1 as well as Comparative Examples 1 and 2.

FIG. 12 shows X-ray diffraction peaks with respect to Fe and a Fe—Sn alloy. For example, large peaks in FIG. 12 show that there are a large number of Fe. Small peaks with triangles represent the presence of metallic Sn, while small peaks with stars, circles, or diamonds represent Fe—Sn intermetallic compounds as example of Fe—Sn alloys. As shown in this figure, in Example 2, the Fe—Sn intermetallic compounds are detected in addition to Fe. In Example 2, metallic Sn and a Fe—Sn intermetallic compound are also detected in addition to Fe.

FIG. 13 shows the weight ratios of Sn to Fe in detection regions b1, b2, c1, and c2 of metal powder 1 according to Example 2. The data shown in FIG. 13 indicates the weight ratio of Sn to Fe induced from the characteristic X-ray intensity ratios of Fe and Sn elements detected by the EDX in detection regions b1, b2, c1, and c2 shown in FIG. 10. Note that FIG. 13 also shows the weight ratio of Si to Fe.

As shown in FIG. 13, detection region b1 corresponding to surface region 5 has Sn at a weight ratio of 0.177, and detection region b2 corresponding to the inside of crystal 3 has Sn at a weight ratio of 0.091. That is, the weight ratio of Sn is higher in surface region 5 of metal powder 1 than inside crystal 3. Detection region c1 corresponding to grain boundary 4 has Sn at a weight ratio of 0.155, and detection region c2 corresponding to the inside of crystal 3 has Sn at a weight ratio of 0.067. That is, the weight ratio of Sn is higher at grain boundaries 4 of metal powder 1 than inside crystal 3.

In this manner, in Example 2, the weight ratio of Sn to Fe is higher at grain boundaries 4 and in surface region 5 than inside crystal 3. As shown in FIG. 6, this powder body structure can reduce the occurrence of rust at dust core 12 including metal powder 1 and the eddy current loss.

### [Manufacturing Method of Coil Component]

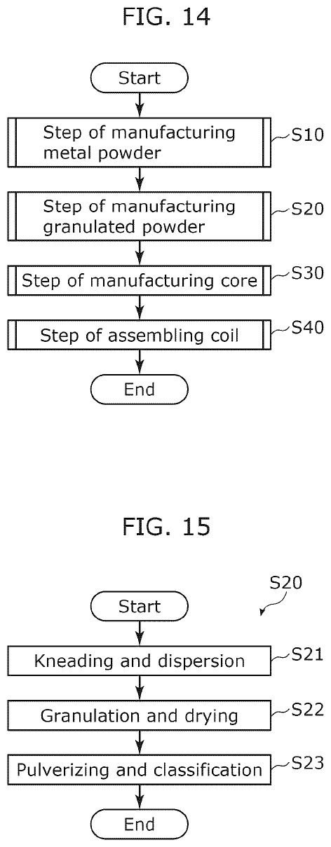

A manufacturing method of the metal powder, the dust core, and the coil component according to this embodiment will be described. FIG. 14 is a flowchart showing a manufacturing process coil component 10 according to this embodiment.

As shown in FIG. 14, the manufacturing process of coil component 10 according to this embodiment includes, for example, a step of manufacturing metal powder (step S10), a step of manufacturing granulated powder (step S20), a step of manufacturing a core (step S30), and a step of assembling a coil (step S40). The step of manufacturing metal powder is for generating the magnetic powder that is metal powder 1. The step of manufacturing granulated powder is for generating the composite magnetic body forming dust core 12 described above. The step of manufacturing a core is for forming dust core 12 by molding the composite magnetic body. In the step of assembling a coil, coil component 10 is completed by assembling dust core 12 described above, conductor 13, and coil supports 14. The steps will be described below in detail. A case will be described where a thermosetting resin is used as a material of non-magnetic resin member 6.

At the step of manufacturing metal powder, metal powder 1 is generated by an atomizing method. Once the molten metal is dissolved and rapidly cooled into a powder body, supersaturated Sn deposits, as metallic Sn or a Fe—Sn alloy, the grain boundaries and the surface region of the powder body. Accordingly, the Sn concentrations become higher at the grain boundaries and in the surface region of the powder body.

FIG. 15 is a flowchart showing the step of manufacturing granulated powder according to this embodiment. As shown in FIG. 15, in the step of manufacturing granulated powder, first, the magnetic powder generated in the step of manufacturing metal powder, a resin material that is a material of non-magnetic resin member 6, and an organic solvent are kneaded and dispersed (step S21). Accordingly, a mixture is generated which contains the organic solvent, the magnetic powder, and the resin material. In step S21, as necessary, other materials, such as an organic metal soap and a coupling agent, may be further added, kneaded, and dispersed.

Examples of the organic solvent include toluene, xylene, ethanol, and methyl ethyl ketone.

The kneading and dispersion are performed as follows. The weighted materials, such as the magnetic powder, the resin material, and the organic solvent, are put into a container, mixed with a rotary ball mill, and disperse. The kneading and dispersion described above are performed at a room temperature, for example. The kneading and dispersion are not limited to those using a rotary ball mill but may be other ones.

After the magnetic powder, the resin material, and the organic solvent are kneaded and dispersed, granulation and drying are performed (step S22). Specifically, the mixture generated in step S21 is subjected to heat treatment at a predetermined temperature. This heat treatment removes the organic solvent from the mixture and provides the granulated powder made of the magnetic powder and the resin material. The predetermined temperature may be set to a temperature capable of removing the organic solvent depending on the boiling point of the organic solvent, for example.

Next, the granulated powder granulated in step S22 is further crushed into powder, the pulverized granulated powder is classified into predetermined particle sizes (step S23). This provides the composite magnetic body made of the granulated powder.

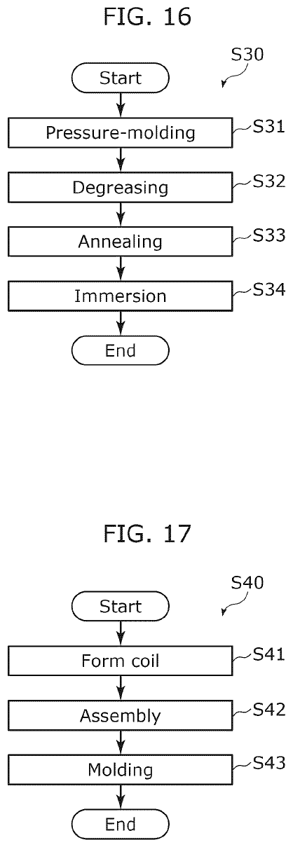

FIG. 16 is a flowchart showing the step of manufacturing a core according to this embodiment. In the step of manufacturing a core, the composite magnetic body obtained in the step of manufacturing granulated powder is molded into dust core 12.

First, the composite magnetic body is pressure-molded into a predetermined shape (step S31). Specifically, the composite magnetic body is put into a mold and compressed into a magnetic body. The magnetic body is in the shape of dust core 12 shown in FIG. 2, for example. At this time, uniaxial molding is performed at a molding pressure within a range from 6 ton/cm² to 12 ton/cm², for example. The molding pressure may fall within a range from 8 ton/cm² to 12 ton/cm².

Next, the magnetic body obtained in step S31 is heated and degreased (step S32). For example, degreasing is performed at a temperature within a range from 200° C. to 450° C. in an inert atmosphere, such as nitrogen gas, or in the air. Depending on the type and characteristics of the resin material for use, the degreasing step may be omitted.

After that, the degreased molded body is annealed (i.e., heat-treated) (step S33). The annealing is performed at a predetermined oxygen partial pressure, for example, within a temperature range from 600° C. to 1000° C. The annealing uses an atmosphere control electric furnace, for example.

The annealed molded body is further immersed into a resin material (step S34). The resin material may be an epoxy resin, for example.

Through the steps described above, dust core 12 is formed which includes the magnetic powder that is metal powder 1 as shown in FIG. 3, and non-magnetic resin member 6. Two dust cores 12 for forming a magnetic body are formed here. Two dust cores 12 and the coil members are assembled as follows into coil component 10.

FIG. 17 is a flowchart showing a step of assembling a coil according to this embodiment.

First, a coil is obtained by winding conductor 13 predetermined times (step S41). In place of step S41, a coil may be prepared with conductor 13 wound in advance a predetermined number of times.

Next, dust core 12, conductor 13, and coil supports 14 are assembled (see FIG. 2) (step S42). In this step, conductor 13 is located to surround cores 12b of two dust cores 12. At this time, cylinder 14b of each of two coil supports 14 is interposed between conductor 13 and core 12b of associated one of two dust cores 12. Also, ring-shaped base 14a of each of two coil supports 14 is interposed between conductor 13 and base 12a of associated one of two dust cores 12. At this time, the ends of cylinders 14b of two coil supports 14 away from ring-shaped bases 14a abut on each other.

Two dust cores 12 are arranged with respective cores 12b and walls 12c abutting on each other. In this manner, coil component 10 is assembled by incorporating conductor 13 between dust cores 12 via coil supports 14. Accordingly, the configuration of conductor 13 wound around cores 12b of dust cores 12 is completed. That is, in two dust cores 12, cores 12b penetrate conductor 13 in the winding direction of conductor 13.

In addition, assembled coil component 10 is molded by a resin material (step S43). Accordingly, coil component 10 is complete.

### [Variation]

Next, a variation of the embodiment will be described. Coil component 10 according to the embodiment uses what is called a “dust core” as a magnetic body. Coil component 20 according to this variation is of a composite metal type in which a coil is incorporated into a magnetic body in a manufacturing process. In the following description of the variation, the differences from the embodiment are mainly described and the description of the common matters will be omitted or simplified.

### [Configuration of Coil Component According to Variation]

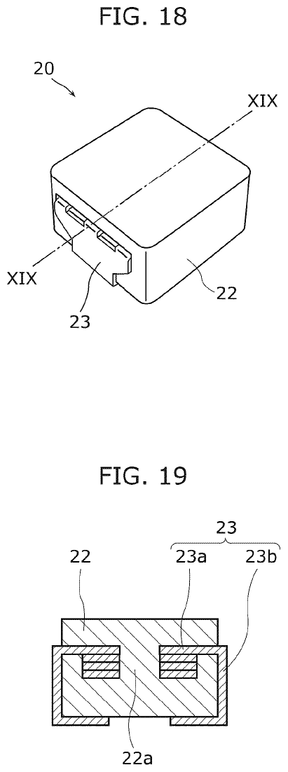

FIG. 18 is a general perspective view showing a configuration of coil component 20 according to this variation. FIG. 19 is a cross-sectional view showing a configuration of coil component 20 according to this variation. FIG. 19 shows a cross-section taken along line XIX-XIX in FIG. 18.

As shown in FIGS. 18 and 19, coil component 20 includes a magnetic body that is a composite magnetic body including metal powder 1, and coil member 23 at least partially located inside the magnetic body. Coil component 20 is an inductor, for example. Dust core 22 includes cylindrical core 22a around the center as viewed in plane. The internal configuration of dust core 22 is the same as the internal configuration of dust core 12 shown in FIG. 3. That is, like dust core 12 of coil component 10 according to Embodiment 1, dust core 22 includes magnetic powder that is metal powder 1 and non-magnetic resin member 6. Coil member 23 is located around cylindrical core 22a of dust core 22.

Coil member 23 includes wound part 23a obtained by winding a conductor a plurality of times, and wiring 23b outside dust core 22. Core 22a of dust core 22 is located as a winding axis of a conductor wound by wound part 23a. The conductor is made of copper, for example. The conductor is made of a material not broken by heat applied at the time of forming coil component 20.

Coil member 23 is integral with dust core 22. Wound part 23a of coil member 23 is embedded inside dust core 22, and wiring 23b is located outside dust core 22.

### [Manufacturing Method of Coil Component According to Variation]

Now, a manufacturing method of coil component 20 according to this variation will be described.

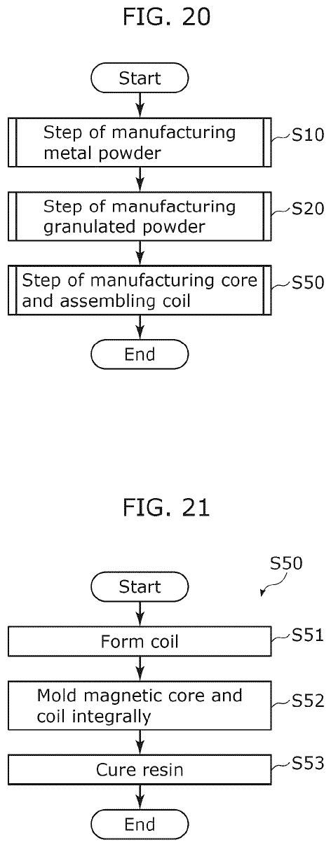

FIG. 20 is a flowchart of a manufacturing process of coil component 20 according to this variation.

As shown in FIG. 20, the manufacturing process of coil component 20 includes, for example, a step of manufacturing metal powder (step S10); a step of manufacturing granulated powder (step S20); and a step of manufacturing a core and assembling a coil (step S50). The step of manufacturing metal powder is for generating the magnetic powder that includes metal powder 1. The step of manufacturing granulated powder is for generating the composite magnetic body forming dust core 22. The step of manufacturing a core is for forming dust core 22 that is a magnetic body and coil member 23 and assembling dust core 22 and coil member 23 to complete coil component 20. A case will be described where a thermosetting resin is used as a material of non-magnetic resin member 6.

The step of manufacturing metal powder and the step of manufacturing granulated powder in the manufacturing process of coil component 20 are the same as in the step of manufacturing metal powder and the step of manufacturing granulated powder shown in the embodiment. The description will be thus omitted.

Now, the step of manufacturing a core and assembling a coil will be described in detail.

FIG. 21 is a flowchart showing the step of manufacturing a core and assembling a coil according to this variation.

As shown in FIG. 21, first, coil member 23 is formed (step S51). Like conductor 13 shown in the embodiment, wound part 23a of coil member 23 is obtained by winding a conductor made of metal, such as copper, a predetermined number of times. In place of step S51, coil member 23 formed in advance may be prepared.

Then, dust core 22 as a magnetic body and coil member 23 are molded integrally (step S52). Dust core 22 may be made of the composite magnetic body manufactured in the step of manufacturing the granulated powder. First, the composite magnetic body classified in the step of manufacturing the granulated powder is put into a mold. At this time, coil member 23 and the composite magnetic body are put into the mold so that the composite magnetic body covers the parts of coil member 23 other than the end of wound part 23a of the conductor of coil member 23.

Subsequently, uniaxial molding is performed at a molding pressure within a range from 1 ton/cm² to 6 ton/cm², for example, to generate a magnetic body. The molding pressure may fall within a range from 4.5 ton/cm² to 6 ton/cm². The molding pressure at this time is lower than the pressure in the uniaxial molding in the step of manufacturing the core of coil component 10 shown in the embodiment, for example. This can reduce the occurrence of breakage of coil member 23 being molded together with the composite magnetic body.

The magnetic body may be in the shape of dust core 22 shown in FIGS. 18 and 19, for example. Note that the shape of the magnetic body is not limited thereto and may be another shape.

In addition, the magnetic body is subjected to thermal curing (step S53). The thermal curing of the magnetic body is performed, at a predetermined oxygen partial pressure, for example within a temperature range from 100° C. to 300° C. Accordingly, the thermosetting resin of non-magnetic resin member 6 is cured, for example. The thermal curing of the magnetic body uses an atmosphere control electric furnace, for example. The thermal curing of the magnetic body may employ another method.

After the thermal curing of the magnetic body, wiring 23b to be provided outside composite magnetic body 22 may be connected to the end of wound part 23a of coil member 23.

Through the steps described above, coil component 20 is complete in which dust core 22 and coil member 23 are integral.

### SUMMARY

Metal powder 1 according to this embodiment is a metal powder containing Fe as a main element, and contains Sn. The Sn content in metal powder 1 is 6.3 wt % or more.

By setting the Sn content to 6.3 wt % or more in this manner, metal powder 1 can be provided which can reduce the eddy current loss and rust.

The weight ratio of Sn to Fe may be higher at least at grain boundary 4 in metal powder 1 or in surface region 5 of metal powder 1 than inside crystal 3 of metal powder 1.

This configuration allows grain boundary 4 containing a higher weight ratio of Sn to cover crystal 3 inside metal powder 1. This configuration also allows surface region 5 containing a higher weight ratio of Sn to cover the inside of metal powder 1. Accordingly, metal powder 1 can be provided which can reduce the eddy current loss and rust.

The weight ratio of Sn to Fe may be higher at grain boundary 4 and in surface region 5 than inside crystal 3.

This configuration allows grain boundary 4 containing a higher weight ratio of Sn to cover crystal 3 inside metal powder 1, and surface region 5 containing a higher weight ratio of Sn to cover the inside of metal powder 1. Accordingly, metal powder 1 can be provided which can reduce the eddy current loss and rust.

At least one of metallic Sn or an Fe—Sn alloy may be present at grain boundary 4 and in surface region 5.

This configuration allows at least one of the metallic Sn or the Fe—Sn alloy to cover crystal 3 inside metal powder 1. This configuration also allows at least one of the metallic Sn or the Fe—Sn alloy to cover the inside of metal powder 1. Accordingly, metal powder 1 can be provided which can reduce the eddy current loss and rust.

The Sn concentration may be higher at least at grain boundary 4 in metal powder 1 or in surface region 5 of metal powder 1 than inside crystal 3 of metal powder 1.

This configuration allows grain boundary 4 with a higher Sn concentration to cover crystal 3 inside metal powder 1. This configuration also allows surface region 5 with a higher Sn concentration to cover metal powder 1. Accordingly, metal powder 1 can be provided which can reduce the eddy current loss and rust.

The Sn content in metal powder 1 may be 20 wt % or less.

Accordingly, metal powder 1 can be provided which can reduce the magnetic saturation.

Metal powder 1 may further contain Si. The Si content in metal powder 1 may be 8 wt % or less.

Accordingly, metal powder 1 can be provided which can reduce, for example, the coercivity of the dust core and less eddy current loss.

A composite magnetic body according to this embodiment includes metal powder 1 described above and a resin.

Accordingly, the composite magnetic body can be provided which can reduce the eddy current loss and rust.

A dust core according to this embodiment includes the composite magnetic body described above.

This can reduce the eddy current loss and rust of the dust core.

A coil component according to this embodiment includes a magnetic body that is the composite magnetic body described above; and a coil member at least partially located inside the magnetic body.

This configuration provides a coil component including a magnetic body that can reduce the eddy current loss and rust.

### OTHER EMBODIMENTS

The metal powder, the composite magnetic body, the dust core, and the coil component according to the embodiment and variation of the present disclosure have been described above. The present disclosure is however not limited to the embodiment and variation.

For example, metal powder 1 contains a very small number of impurities, which are different from Fe, Si, and Sn, as a contamination.

For example, the present disclosure includes electrical components using the dust core described above. Examples of the electrical components include inductance components, such as a high-frequency reactor, an inductor, and a transformer. The present disclosure also includes power supply devices including the electrical components described above.

The present disclosure is not limited to the embodiment and variation described above. The one or more aspects may include forms obtained by various modifications to the foregoing embodiment and variation that can be conceived by those skilled in the art or forms achieved by freely combining the elements in the foregoing embodiment and variation without departing from the scope and spirit of the present disclosure.

### REFERENCE SIGNS LIST

1 metal powder
2 internal region
3 crystal
4 grain boundary
5 surface region
6 non-magnetic resin member
10, 20 coil component
12 dust core
12a base
12b core
12c wall
13 conductor
14 coil support
14a base
14b cylinder
22 dust core
22a core
23 coil member
23a wound part
23b wiring

1. Metal powder containing Fe as a main element, the metal powder comprising:
Sn, wherein
a Sn content in the metal powder is 6.3 wt % or more.

2. The metal powder according to claim 1, wherein
a weight ratio of Sn to Fe is higher at least at a grain boundary in the metal powder or in a surface region of the metal powder than inside a crystal of the metal powder.

3. The metal powder according to claim 2, wherein
a weight ratio of Sn to Fe is higher at the grain boundary and in the surface region than inside the crystal.

4. The metal powder according to claim 3, wherein
at least one of metallic Sn or an Fe—Sn alloy is present at the grain boundary and in the surface region.

5. The metal powder according to claim 1, wherein
a Sn concentration is higher at least at a grain boundary in the metal powder or in a surface region of the metal powder than inside a crystal of the metal powder.

6. The metal powder according to claim 1, wherein the Sn content in the metal powder is 20 wt % or less.

7. The metal powder according to claim 6, further comprising:
Si, wherein
a Si content in the metal powder is 8 wt % or less.

8. A composite magnetic body comprising:
the metal powder according to claim 1; and
a resin.

9. A dust core comprising:
the composite magnetic body according to claim 8.

10. A coil component comprising:
a magnetic body including the composite magnetic body according to claim 8; and
a coil member at least partially located inside the magnetic body.
